(19) United States
(12) Patent Application Publication
(10) Pub. No.: US 2026/0070577 A1
(43) Pub. Date: Mar. 12, 2026

(54) COMPUTER-IMPLEMENTED METHOD FOR GENERATING A CONTROL COMMAND FOR AN AUTONOMOUS VEHICLE

(71) Applicant: Robert Bosch GmbH, Stuttgart (DE)

(72) Inventors: Ali Keysan, Kirchentellinsfurt (DE); Barbara Rakitsch, Stuttgart (DE); Andreas Look, Kleinsendelbach (DE); Eitan Kosman, Haifa (IL)

(21) Appl. No.: 18/811,848

(22) Filed: Aug. 22, 2024

(30) Foreign Application Priority Data
Sep. 1, 2023 (DE) 10 2023 208 451.1

(51) Int. Cl. B60W 60/00; G05B 13/02; G06T 7/20; G06T 7/70; G06V 20/56

(52) U.S. Cl. CPC B60W 60/001; G05B 13/027; G06T 7/20; G06T 7/70; G06V 20/56; B60W 2420/403; B60W 2420/408; G06T 2207/20084; G06T 2207/30241; G06T 2207/30252

(57) ABSTRACT

A computer-implemented method for generating a control command for an autonomous vehicle. The method includes: capturing sensor data by at least one sensor of the vehicle; generating an input text from the sensor data; interpreting the input text using a machine learning algorithm; and generating a control command for the vehicle from the interpreted input text.

### CROSS REFERENCE

The present application claims the benefit under 35 U.S.C. § 119 of German Patent Application No. DE 10 2023 208 451.1 filed on Sep. 1, 2023, which is expressly incorporated herein by reference in its entirety.

### FIELD

The present invention relates to the prediction of the movement of other road users and to the generation of control commands in the context of autonomous driving.

In a world where technology and mobility are developing at a rapid pace, autonomous driving is inexorably becoming the focus of research and industry. The vision of vehicles that can navigate independently through traffic has already made impressive progress and poses a number of complex challenges to both automotive manufacturers and technology companies. One of the key challenges is to precisely predict the movements of road users, be they other vehicles, pedestrians, or cyclists. These predictions form the foundation for safe and efficient vehicle control in an increasingly connected and dynamic traffic surroundings.

Autonomous driving promises not only an increase in road safety but also optimized traffic flow control and a reduction in fuel consumption. However, in order to realize these advantages, autonomous vehicles must not only perceive their surroundings but also be able to precisely predict the intentions and actions of other road users. These predictions are essential in order to be able to respond in time, whether by adjusting the own driving speed, by changing lanes or by avoiding collisions.

Predicting the movements of other road users is a complex process, which relies on a combination of advanced technologies and data processing. Autonomous vehicles are equipped with a wide range of sensors, including lidar, radar, cameras and ultrasonic sensors. These sensors continuously capture information about the surroundings of the vehicle, such as the position, speed and movement direction of other road users. The data from these sensors are captured in real time and serve as the basis for the prediction algorithms.

The collected sensor data are combined and analyzed in a process called data fusion. In doing so, various data sources are combined in order to create a comprehensive image of the surroundings. Advanced object recognition algorithms are used to identify road users and recognize their positions and movement patterns.

After recognizing road users, autonomous vehicles model the behavior of these road users. The models used in this respect are often based on machine learning and can use historical movement data to make predictions about how road users might behave in certain situations. Such models can be complex and take into account various factors such as traffic rules, road types, weather conditions and individual behavior patterns.

Based on the captured data and behavioral models, the autonomous vehicle makes predictions about the future movements of the recognized road users. These predictions are often represented as trajectories, which describe the expected route and speed of the road users. This process is referred to as trajectory prediction.

Since the movements of road users are often uncertain and variable, modern autonomous vehicles also take uncertainties into account in their predictions. Probability distributions and uncertainty measures are used to estimate various possible scenarios and assess the risks of collisions or other undesirable events.

For controlling an autonomous vehicle, the predictions are continuously updated as the surroundings changes. If new information is captured or the behavior of the road users changes, the autonomous vehicle adjusts its predictions accordingly.

Overall, the precise prediction of the movements of other road users in the context of autonomous driving requires close integration of sensors, data processing, machine learning and probabilistic modeling. The ability to accurately anticipate traffic situations is of critical importance in order to ensure that autonomous vehicles respond appropriately and can interact safely with their surroundings.

An object of the present invention is to provide a method for generating a control command for an autonomous vehicle.

This object may be achieved by certain features of the present invention.

### SUMMARY

According to a first aspect of the present invention, the object may be achieved by a computer-implemented method for generating a control command for an autonomous vehicle. According to an example embodiment of the present invention, the method includes the following steps:
capturing sensor data by at least one sensor of the vehicle;
generating an input text from the sensor data;
interpreting the input text using a machine learning algorithm; and
generating a control command for the vehicle from the interpreted input text.

The input text can in particular be a predefined text prompt, into which the sensor data are inserted. To this end, a computing unit that processes the sensor data can encode them in such a way that the sensor data can be automatically inserted into the suitable places in the text prompt.

For interpretation, the computing unit uses a machine learning algorithm.

A machine learning algorithm is an algorithm that was developed in order to automatically recognize patterns and relationships in data and to make predictions or decisions. It is created through the training with existing data and can then be applied to new, unknown data in order to generate predictions or classifications.

A machine learning algorithm can take various forms such as linear models, decision trees, support vector machines, neural networks and many others. It is optimized by learning from the training data in that it recognizes patterns and rules in order to make the best possible predictions or classifications for new data.

The effectiveness of a machine learning algorithm depends on various factors, including the quality and quantity of the training data, the choice of the algorithm, the model configuration, and the assessment of the model on the basis of evaluation metrics. The model is continuously improved and optimized in order to maximize accuracy and performance.

According to an example embodiment of the present invention, the machine learning algorithm is configured such that it analyzes and evaluates the text message after it is received. To this end, the text message is used word for word as an input vector for the machine learning algorithm. A probability of the correctness is ascertained for a large number of possible answers to the interpreted input text. Through prior training, the correctness has been encoded into the model of the machine learning algorithm. The algorithm tries to predict as accurately as possible trajectories that can be used to generate a suitable control command.

The control commands for the autonomous vehicle can, for example, relate to the steering, the acceleration and/or the braking behavior of the vehicle. In modern vehicles, individual wheels can be braked or driven individually in order to improve the control of the vehicle. The control command can therefore basically be a vector with a plurality of instructions for the different subcomponents of the vehicle.

Machine learning algorithms intended for text processing are constructed differently than those that only process numbers. Thus, generating a control command from the interpreted input text represents an alternative method to generating control commands in a conventional manner. Usually, the raw sensor data are used for the trajectory prediction, which is then used to calculate predicted trajectories.

The present invention thus provides an alternative to the methods in which the control commands are not generated from a text. This achieves the object of the present invention.

In one example embodiment of the present invention, HD maps are used in addition to the sensor data to generate the input text. The term “HD map” refers to a high-resolution digital map created specifically for autonomous vehicles. An HD map is much more than a conventional road map since it contains additional details and information that are of critical importance for precisely navigating and controlling autonomous vehicles.

An HD map offers a very high level of accuracy with respect to courses of roads, lane markings, traffic signs, buildings and other objects. This is important in order to make it possible for the autonomous vehicle to accurately understand its surroundings. It may also contain information about the topological structure of roads, including the number of lanes, directional lanes, possibilities for turning and for turning around, and connection points between various roads. HD maps may contain traffic signs, traffic signals and light phases of traffic lights. This information is important so that the autonomous vehicle can accurately interpret traffic rules and traffic signals.

HD maps can also contain information about obstacles, construction sites, accident sites and other potential hazards. Since road conditions and traffic conditions can change, it is important that HD maps are updated regularly. Some systems can also collect real-time data from other vehicles in order to provide accurate information about traffic flow and road condition.

In one example embodiment of the present invention, the machine learning algorithm is a neural network.

Due to their structure, composed of neurons arranged in layers, artificial neural networks are particularly suitable for recognizing patterns. The movements of other road users are subject to physical laws, such as inertia. In addition, it is to be assumed that most road users follow predefined paths, for example, a lane or a walkway or bikeway. These laws and boundary conditions form patterns, albeit highly complex ones. These patterns can be recognized particularly effectively by an artificial neural network.

In one example embodiment of the present invention, the neural network comprises a plurality of layers and at least one layer is intended for interpreting the input text.

Neural networks usually comprise a plurality of layers. The number of layers may vary depending on the use of the neural network. Generally, neural networks comprise an input layer, one or more hidden layers, and an output layer.

According to an example embodiment of the present invention, the input layer is the starting point of the neural network. This is where the input data are fed into the network. These fed-in data can, for example, be text or other numerical information. For example, a text is cut into smaller pieces (=tokens) by a so-called tokenizer. The tokens can then be converted into numerical values by embedding.

The hidden layers are located between the input layer and the output layer. Each hidden layer is composed of neurons, also called “nodes” or “units.” In these hidden layers, calculations are performed in order to extract patterns and features from the input data. This is where the interpretation of the input text takes place.

The output layer provides the results of the neural network. Depending on the task, it may have a single output or a plurality of outputs. The output of the output layer may, for example, comprise one or more control commands for the autonomous vehicle but also a trajectory prediction, which is then translated into control commands by another module.

According to an example embodiment of the present invention, the neural network may also comprise a plurality of subnetworks, each of which has its own tasks. The interpretation of the input text can be such a task for which a separate subnetwork is configured.

Configuring subnetworks has the advantage that the subnetwork has its own cost function during training so that the function of interpreting the text can be controlled and independently optimized.

In one example embodiment of the present invention, the neural network or a subnetwork thereof is trained with a large language model to interpret the input text.

A large language model is a term that refers to language models that use huge amounts of text data to learn the ability to interpret and generate natural language. These models are often used in machine text processing and can perform various tasks such as machine translation, text generation, text classification, question-answering systems, and more. Large language models are special models of neural networks. Preferably, the neural network is trained with the large language model on a trajectory prediction dataset.

Due to their structure, neural networks, in particular when trained with a large language model, are particularly well suited for text processing.

In a further example embodiment of the present invention, the large language model comprises a transformer architecture. Transformer architectures, also referred to as transformers for short, are specific architectures for neural networks that are based on the mechanism of attention and are used to process sequences such as texts. They have proven to be extremely powerful in machine text processing.

The main idea behind the transformer is that it is completely based on the mechanism of attention in order to model the relationships within a text. Traditional sequential models such as LSTM or RNN have difficulties to capture long dependencies efficiently. The transformer, on the other hand, can directly access the entire input text and model relationships between words in a parallel manner, which considerably improves the training speed and model performance.

The transformer architecture is composed of a stack of identical layers. Each layer is divided into two main components: the multi-head self-attention mechanism and the position-wise feedforward network.

According to an example embodiment of the present invention, the multi-head self-attention mechanism is the heart of the transformer. Here, the input text is converted into a query, a key and a value. For each word, a so-called attention weight is calculated, which indicates how relevant the other words in the text are to this word. Each word can then obtain its representation through a weighted combination of the values of the other words. This generates so-called word embedding vectors. For example, each word of the input is broken down into tokens X=(x1, . . . , x_N), and these tokens are then converted into a numerical representation by embedding. Here, N is the number of tokens, and x_n are the features of a token.

The attention weights are calculated multiple times in so-called heads in order to generate various representations of the attention context. The results are then concatenated and combined again by a linear transformation.

The position-wise feedforward network comprises two linear transformations, which are applied independently to each word. It is a non-sequential part of the architecture since each vector is processed separately.

Since a transformer architecture has no built-in information about the order of the words, positional information is added through positional encodings. These positional encodings are added to the word embedding vectors in order to take the influence of the positions into account.

The transformer architecture can be divided into an encoder and a decoder. The encoder processes the input sequence, and the decoder generates the output sequence. For some tasks, such as machine text processing, it is possible to use a plurality of transformer layers for the encoder and decoder to increase the performance of the model. Since no output text is generated within the scope of the present invention, a decoder in the architecture can be dispensed with.

Overall, the transformer architecture advantageously makes highly parallel and efficient processing of texts possible, which leads to an increase in performance in text processing tasks. By using attention mechanisms, the model can specifically access relevant information and recognize complex dependencies within the input texts, which are then used to generate the control commands.

In one example embodiment of the present invention, the sensor data comprise camera images and/or radar sensor data.

The use of camera images and radar sensors as sensor data provides multiple advantages that make comprehensive and reliable perception of the vehicle surroundings possible. These sensor technologies complement one another and play a critical role in autonomous vehicles being able to obtain a precise interpretation of their surroundings and to navigate safely.

Cameras provide high-resolution images that make a detailed view of the surroundings possible. This is particularly important for accurately identifying and classifying smaller objects such as traffic signs, pedestrians or bicycles.

In addition, cameras can capture the surroundings in color, which improves the ability of the autonomous vehicle to recognize visual features such as traffic light colors or color changes on the road. Modern image processing algorithms and deep learning algorithms make it possible to recognize these objects in the sensor data and classify them.

Cameras can also capture information about the behavior of other road users by analyzing their movement patterns and speeds. This is critical for predicting their future actions.

Radar sensors are insensitive to light conditions such as darkness, fog or heavy rain. They work on the basis of radio waves and thus offer reliable perception in various environmental conditions.

Radar sensors can measure distances to objects extremely accurately. This makes it possible to accurately capture the relative position of vehicles and other obstacles. Radar sensors can also precisely capture the speeds of other vehicles and road users. This is essential to make collision avoidance maneuvers and accurate prediction of movements possible. Additionally, radar sensors can provide metadata about objects, including size, speed and direction, which helps distinguish between stationary and moving objects.

Camera images and radar sensor data advantageously complement one another since they can each perceive different aspects of the surroundings. The fusion of data from these two sources makes a more comprehensive and reliable capture of information possible. By integrating these technologies, autonomous vehicles can navigate more safely, handle complex traffic scenarios and respond appropriately despite changing conditions.

In one example embodiment of the present invention, the sensor data comprise information on the position of the vehicle relative to its surroundings.

Immobile objects such as buildings, vegetation, signs and traffic signs but also lane markings may be present in the surroundings. The surroundings can therefore be used as a reference to relate one's own movement to the movement of other road users. For example, a camera can detect whether the vehicle is in the middle of a lane by measuring the distance to the lane markings to the left and right of the vehicle.

Including the surroundings in the generation of the control command advantageously results in an optimization of the generated control command.

In one example embodiment of the present invention, movement vectors are furthermore ascertained from the sensor data, and the control command is generated from the interpreted input text and the movement vectors.

In this example embodiment, the generation of the control commands is based on two different methods that complement one another and act as a corrective for one another. This can increase the failure safety of the entire system but also the protection against incorrect outputs.

In a further aspect, the present invention relates to a computer program comprising program code for performing a computer-implemented method for generating a control command for an autonomous vehicle as described above when the computer program is executed on a computer.

In a further aspect, the present invention relates to a computer-readable data carrier comprising program code of a computer program for performing a computer-implemented method for generating a control command for an autonomous vehicle as described above when the computer program is executed on a computer.

In a further aspect, the present invention relates to a system for generating a control command for an autonomous vehicle, wherein the system is designed to perform a computer-implemented method as described above.

Thus, a method, a computer program, a computer-readable data carrier and a system are specified according to the present invention.

The described example embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The FIGURES are intended to impart further understanding of the example embodiments of the present invention. They illustrate example embodiments and, in connection with the description, serve to explain principles and concepts of the present invention.

Other embodiments and many of the mentioned advantages are apparent from the FIGURES. The illustrated elements of the FIGURES are not necessarily shown to scale relative to one another.

FIG. 1 shows a system for generating a control command for an autonomous vehicle, according to example embodiment of the present invention.

FIG. 2 shows an alternative system for generating a control command for an autonomous vehicle, according to an example embodiment of present invention.

FIG. 3 shows a further alternative system for generating a control command for an autonomous vehicle, according to an example embodiment of the present invention.

FIG. 4 schematically shows the sequence of a method according to one example embodiment of the present invention.

In the FIGURES, identical reference signs denote identical or functionally identical elements, parts or components, unless stated otherwise.

### DETAILED DESCRIPTION OF EXAMPLE EMBODIMENTS

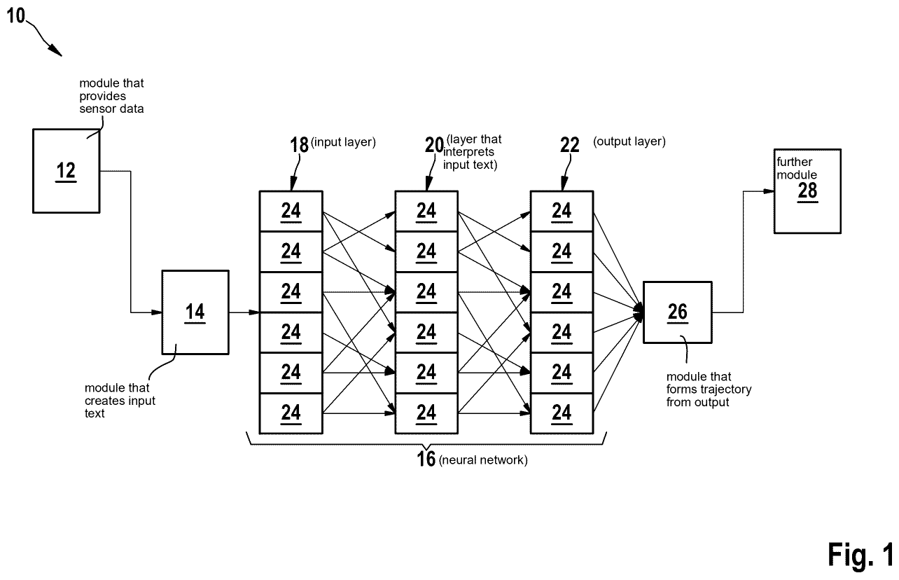

FIG. 1 schematically shows a system 10 comprising a machine learning algorithm, in particular a neural network, for generating a control command.

The system 10 comprises a module 12 that provides the sensor data. The sensor data may preferably be in a form in which they can be further processed by the machine learning algorithm. The current speed of the vehicle may, for example, be specified as a numerical value in m/s.

Preferably, previous algorithms and modules have processed the sensor data such that they can now be incorporated into a text as numerical values. To this end, the system 10 comprises a module 14. The module 14 creates an input text by feeding the sensor data from module 12 into a prompt.

In the context of text processing by a large language model, the term “prompt” refers to a source text or the instruction given to such a model in order to perform a specific task. A prompt may be a question, a request, a description, or any form of input that asks the model to respond or to generate further text.

The prompt acts as initial information, which provides the model with the context and the direction for the desired output. It determines what type of answer or continuation the model should generate. The quality of the prompt directly influences the quality and relevance of the answer of the model. A precise, clearly worded prompt can help to obtain more accurate and goal-oriented answers.

When formulating prompts, it is important to be specific and give clear instructions in order to achieve the desired results and minimize potential misunderstandings or unwanted outputs.

For Example, but not in a Limiting Manner, a Prompt May Look Like this:
“You are an expert self-driving-car model, that can predict the future trajectory for a given vehicle, while also incorporating its current and past states, its current and possible future lanes and also information about other vehicles, pedestrians, drivable areas and other important sets of features.
Task: Please predict the future trajectory for the given vehicle for the next 6 seconds, from a set of fixed trajectories.

### Context Information:

The 2D coordinate system (x, y) is from the prediction vehicle's own frame of view.

Lane information is encoded as the 4 control points of a cubic Bezier curve. The first and last control point match with the beginning and end of the lane.

### Prediction Vehicle:

Category: vehicle.car
Current speed: 7.12 [m/s]
Current acceleration: 0.23 [m/s²]
Current yaw rate: 4.11 [2π/s]
Past (x, y) positions in meters, sampled at 2 Hertz:

| Time[s] | x [m] | y[m] |
|---|---|---|
| −2.0 | 0.83 | −15.24 |
| −1.5 | 0.27 | −10.56 |
| −1.0 | 0.03 | −7.07 |
| −0.5 | 0.01 | −3.56 |

### Current Lane Information (Bezier Curve, as Explained Above):

| x | y |
|---|---|
| 0.88 | −2.24 |
| 1.74 | 1.87 |
| 2.62 | 5.94 |
| 3.47 | 10.05 |

### Possible Outgoing Lane Information (Bezier Curve, as Explained Above):

| x | y |
|---|---|
| 3.47 | 10.05 |
| 4.59 | 15.21 |
| 5.33 | 20.46 |
| 5.68 | 25.72 |

| x | y |
|---|---|
| 3.47 | 10.05 |
| 5.13 | 20.95 |
| 22.34 | 21.15 |
| 24.43 | 10.3 |

### Predicted Trajectory:

The last line indicates that the system 10 is requested to generate a trajectory for the autonomous vehicle. To this end, the input text is input into a neural network 16. In the illustrated embodiment, the neural network comprises three layers 18, 20 and 22. In other embodiments, the neural network may comprise many more layers. However, the system 10 would also work without the last line “Predicted trajectory” since the LLM is specialized for this task. This means that the weights of the LLM are retrained such that the predicted trajectory is as close as possible to the ground truth.

Layer 18 is the input layer, which receives the input text. Layer 20 is the layer that interprets the input text, and layer 22 is the layer that generates a trajectory for the autonomous vehicle from the interpreted input text. Each layer comprises a plurality of neurons 24 or nodes, which are connected to one another. The connection shown is to be understood schematically. Real neural networks 16 may have different numbers of neurons 24 in each layer, which neurons are connected to one another differently than shown.

In a module 26, a trajectory is formed from the output of the neurons 24 of the output layer 22. The trajectory is then passed to a further module 28, which generates a control command for the vehicle from the trajectory. The trajectory itself is not a quantity with which the vehicle can work. Instead, the module 28 translates the trajectory into specific instructions, for example brake with braking force x for time period t and steer to the right by angle α.

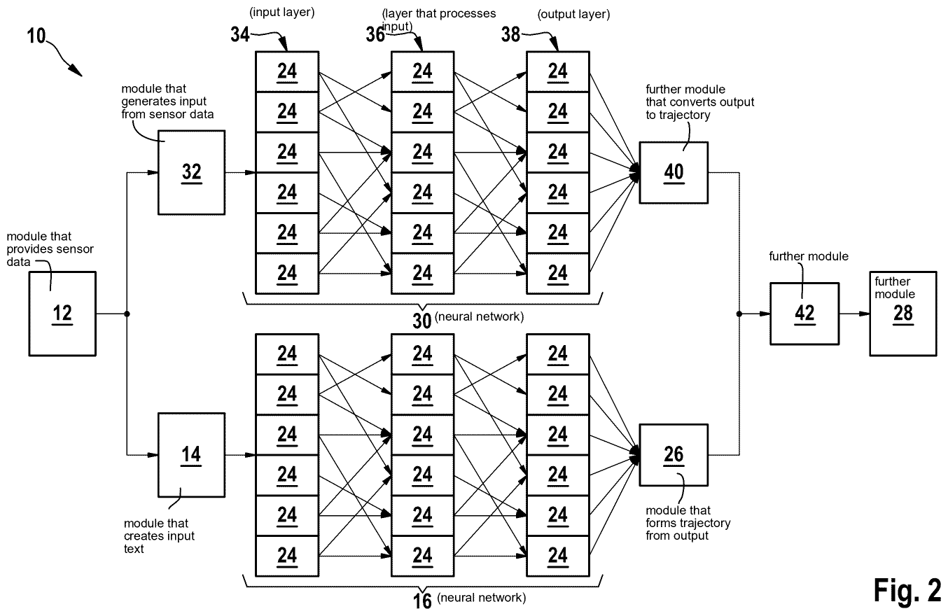

FIG. 2 shows an alternative system 10 comprising two neural networks 16 and 30. The input for the neural network 30 is generated from the sensor data in a module 32. This input may, for example, comprise a two-dimensional map with position information of the surroundings, any lane markings and/or other road users.

The neural network 30, like the neural network 16, is composed of three layers 34, 36 and 38. Layer 34 is an input layer, which receives the input from module 32. Layer 36 processes the input, and layer 38 generates an output, which is converted into a trajectory for the autonomous vehicle in a further module 40.

There are now two trajectories that were generated by the modules 26 and 40. The two trajectories must be assessed so that only one trajectory is converted into a control command, since the autonomous vehicle can only follow one trajectory. The comparison and assessment of the trajectories are carried out in a further module 42 so that the remaining trajectory can then be passed to the module 28.

In this embodiment, the input text and its interpretation is used as a corrective for another data processing method, or vice versa.

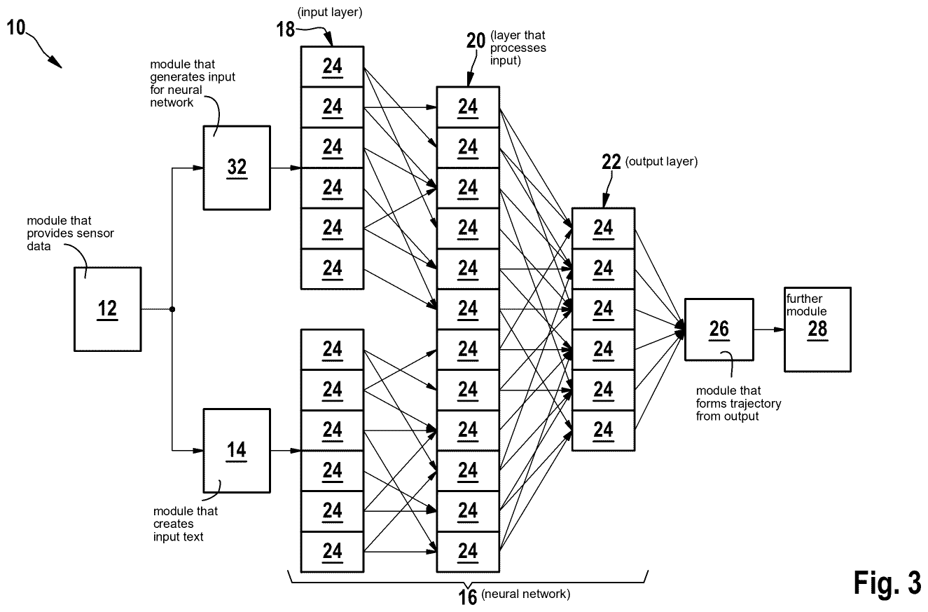

FIG. 3 shows a further embodiment of a system 10. The illustrated system 10 comprises a neural network 16 composed of three layers of neurons 24. A portion of the neurons of the input layer 18 receives the input data from the module 32. Another portion of the neurons 24 of the input layer 18 receives the input text from the module 14.

The neural network 16 is constructed such that it processes the input from the module 32 together with the input text from module 14 in a layer 20. An output is then generated in the output layer 22 and processed by module 26 to form a trajectory. This trajectory is processed by module 28 to form a control command for the autonomous vehicle.

In this embodiment, the input text and its interpretation are processed in parallel and in addition to the input data from module 32.

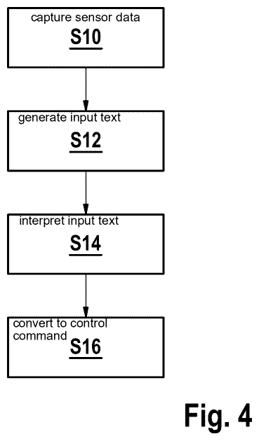

FIG. 4 schematically shows the flow of the method according to one embodiment. In step S10, sensor data are first captured by a sensor of the autonomous vehicle. The sensor data can in particular be camera images or radar sensor data.

In step S12, an input text is generated from the sensor data. Generating the input text may, for example, comprise supplementing a prompt with the sensor data.

In step S14, the input text is interpreted. To this end, a machine learning algorithm, in particular a neural network pre-trained with a large language model, is used. The input text is then converted from a trajectory prediction to a control command for the autonomous vehicle in step S16.

Steps S10 to S16 are repeated at regular intervals in order to ensure continuous control of the autonomous vehicle. For example, steps S10 to S16 may be performed every millisecond.

What is claimed is:

1. A computer-implemented method for generating a control command for an autonomous vehicle, comprising the following steps:
capturing sensor data by at least one sensor of the vehicle;
generating an input text from the sensor data;
interpreting the input text using a machine learning algorithm; and
generating a control command for the vehicle from the interpreted input text.

2. The computer-implemented method according to claim 1, wherein the machine learning algorithm is a neural network.

3. The computer-implemented method according to claim 2, wherein the neural network includes a plurality of layers, and wherein at least one layer is provided for the interpretation of the input text.

4. The computer-implemented method according to claim 2, wherein the neural network or a subnetwork of the neural network is trained with a large language model to interpret the input text.

5. The computer-implemented method according to claim 1, wherein the sensor data include camera images and/or radar sensor data.

6. The computer-implemented method according to claim 1, wherein the sensor data include information on a position of the vehicle relative to its surroundings.

7. The computer-implemented method according to claim 1, wherein movement vectors are ascertained from the sensor data, and wherein the control command is generated from the interpreted input text and the movement vectors.

8. A non-transitory computer-readable data carrier on which is stored program code of a computer program for generating a control command for an autonomous vehicle, the computer program, when executed by a computer, causing the computer to perform the following steps:
capturing sensor data by at least one sensor of the vehicle;
generating an input text from the sensor data;
interpreting the input text using a machine learning algorithm; and
generating a control command for the vehicle from the interpreted input text.

9. A system configured to generate a control command for an autonomous vehicle, wherein the system is configured to:
capture sensor data by at least one sensor of the vehicle;
generate an input text from the sensor data;
interpret the input text using a machine learning algorithm; and
generate a control command for the vehicle from the interpreted input text.
